(19) United States
(12) Patent Application Publication
(10) Pub. No.: US 2006/0185730 A1
(43) Pub. Date: Aug. 24, 2006

(54) Valve for pressurized canister with non-constant thread

(76) Inventor: Eric Scott, Jupiter, FL (US)

Correspondence Address: BANNER & WITCOFF, LTD., 28 STATE STREET, 28th FLOOR, BOSTON, MA, 02109-9601, US

(21) Appl. No.: 11/060,929

(22) Filed: Feb. 18, 2005

(51) Int. Cl. F16K 17/40

(52) U.S. Cl. 137/68.19

(57) ABSTRACT

A valve for a pressurized canister includes a housing having a central aperture extending therethrough, a longitudinal axis, and a thread formed on an exterior surface thereof. A sealing member is positioned in an axially outward end of the central aperture and is axially moveable with respect to the housing to seal and unseal the central aperture. The thread has a characteristic that has a non-constant value along the longitudinal axis of the housing.

### FIELD OF THE INVENTION

This invention relates generally to a valve for a pressurized canister, and, in particular, to a valve for a pressurized canister having improved safety features.

### BACKGROUND OF THE INVENTION

Canisters for containing pressurized fluids, for example, gases such as nitrogen, air and CO₂, are well known. These canisters typically include a valve with external threads that is threaded into an aperture formed in the canister. The valve includes a spring-loaded pin that is activated by an adapter on another device to release a desired amount of pressurized fluid to the device, such as an ASA adapter that may be attached to a regulator. The adapter is typically connected to the valve by way of external threads on the housing of the valve that are received by internal threads formed in an aperture in the adapter. Such canisters are used in many applications including, for example, paintball guns.

A potential safety issue is present when the canister contains pressurized fluid. It is possible for a user, when trying to remove the valve and canister from the regulator, to unscrew the valve from the canister, rather than the valve from the regulator. This may happen, for example, when thread sealant on the threads of the valve and the threads of the canister has been inadvertently omitted or wrongly applied. If the valve is unscrewed from the canister while the canister is pressurized, the pressurized fluid can propel the canister away from the valve with great force, creating a significant safety risk.

It is an object of the present invention to provide a valve for a pressurized canister that reduces or overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

The principles of the invention may be used to advantage to provide a valve for a pressurized canister having improved safety features.

In accordance with a first preferred embodiment, a valve for a pressurized canister includes a housing having a central aperture extending therethrough, and a thread formed on an exterior surface thereof. A sealing member is positioned in an axially outward end of the central aperture and is axially moveable with respect to the housing to seal and unseal the central aperture. The thread has a characteristic that has a non-constant value along its length.

In accordance with another preferred embodiment, a valve for a pressurized canister includes a housing having a central aperture extending therethrough, a first set of external threads, and a second set of external threads positioned radially inwardly of the first set of external threads. A sealing member is positioned in an axially outward end of the central aperture and is axially moveable to seal and unseal the central aperture. A spring biases the sealing member axially outwardly. The thread has a characteristic that has a non-constant value along its length.

In accordance with a further preferred embodiment, a valve assembly for a pressurized canister includes a canister having a threaded opening. A housing has a central aperture extending therethrough, a second aperture in fluid communication with an exterior of the housing and the central aperture, a first set of external threads, and a second set of external threads positioned radially inwardly of the first set of external threads. The second set of external threads is engageable with the threaded opening of the canister. A pressure relief valve is positioned in the second aperture. A sealing member is positioned in an axially outward end of the central aperture and is axially moveable to seal and unseal the central aperture. A spring biases the sealing member axially outwardly. The second set of external threads has a thread characteristic that has a non-constant value along its length and the threaded opening of the canister has a constant value for that thread characteristic.

Substantial advantage is achieved by providing a valve for a pressurized canister. In particular, certain preferred embodiments of the present invention insure that the valve is secured to the canister with the correct amount of force, thereby reducing the risk of the valve inadvertently being loosened from the canister while the canister is pressurized

These and additional features and advantages of the invention disclosed here will be further understood from the following detailed disclosure of certain preferred embodiments.

### BRIEF DESCRIPTION OF THE DRAWINGS

FIG. 1 is a section view of a valve in accordance with a preferred embodiment of the present invention, shown installed on a canister in a first closed condition.

FIGS. 2-7 are enlarged views of alternative embodiments of the threaded portion of the valve of FIG. 1 that engages with the canister.

The figures referred to above are not drawn necessarily to scale and should be understood to provide a representation of the invention, illustrative of the principles involved. Some features of the valve for a pressurized canister depicted in the drawings have been enlarged or distorted relative to others to facilitate explanation and understanding. The same reference numbers are used in the drawings for similar or identical components and features shown in various alternative embodiments. Valves for pressurized canisters as disclosed herein would have configurations and components determined, in part, by the intended application and environment in which they are used.

### DETAILED DESCRIPTION OF CERTAIN PREFERRED EMBODIMENTS

The present invention may be embodied in various forms. The embodiments described herein are directed to a valve for use with a pressurized canister. One such pressurized canister is one that is secured to a regulator or other device for a paintball gun. It is to be appreciated that other applications of the valve described herein are considered to be within the scope of the present invention, and other such applications will become readily apparent to those skilled in the art, given the benefit of this disclosure.

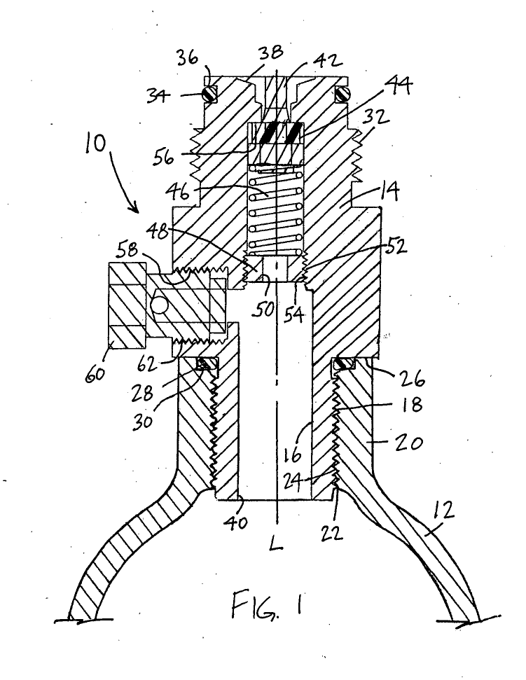

A preferred embodiment of a valve 10 for a pressurized canister 12 is shown in FIG. 1. Canister 12 contains a pressurized fluid, such as CO₂. Valve 10 includes a housing 14 having a central aperture 16 extending therethrough. Housing 14 may be substantially cylindrical or of any other desired shape. A first set of external threads 18 are provided on an axially inner portion of the exterior surface of housing 14. Housing 14 and valve 10 share a longitudinal axis L.

Unless otherwise stated, or otherwise clear from the context below, directional terms used herein, such as rearwardly, forwardly, inwardly, downwardly, upwardly, etc., refer to directions relative to valve 10 and canister 12 to which it is attached. In the embodiment illustrated in FIG. 1, valve 10 and canister 12 are disposed substantially vertically. However, it is to be appreciated that valve 10 and canister 12 can be in any orientation. As seen here, radially outwardly with respect to valve 10 refers to a direction extending away from central aperture 16 toward the exterior of valve 10, which is seen to be horizontal in this embodiment, that is, to the left or right as seen in FIG. 1. Axially outwardly refers to a direction extending away from the interior of canister 12, that is, upwardly toward the top of the page as seen in FIG. 1. Naturally, axially inwardly refers to a direction extending toward the interior of canister 12, that is, toward the bottom of the page as seen in FIG. 1.

A neck 20 of canister 12 has an aperture 22 formed therein, with internal threads 24 formed on the surface of aperture 22. A shoulder 26 formed on housing 14 abuts the axially outward edge of neck 20. A seal such as an O-ring 28 is positioned in a recess 30 formed at the axially outward end of aperture 22, ensuring a good seal between valve 10 and canister 12. External threads 18 of housing 14 mate with internal threads 24 of canister 12 to secure valve 10 to canister 12. In certain preferred embodiments, a thread locking sealant (not shown) is applied to internal threads 24 and external threads 18.

It is to be appreciated that the phrases “thread” and “threads” may be used interchangeably herein, and are both intended to encompass embodiments where a single thread extends about a member as well as embodiments where a plurality of threads extend about a member.

A second set of external threads 32 is provided on an axially outward portion of housing 14. External threads 32 mate with corresponding internal threads (not shown) on a device to which valve 10 and canister 12 are attached, such as an adapter (e.g., an ASA adapter), which itself may be attached to a regulator, for a paintball gun. A seal such as an O-ring 34 is positioned in an annular recess 36 formed in an exterior surface of housing 14 proximate its axially outward end, providing a seal between valve 10 and the device to which it is attached.

Central aperture 16 has a first end 38 open to the surrounding environment, or to a device to which valve 10 is attached, and a second end 40 that is open to an interior of canister 12. A sealing member such as a pin 42 with a seal 44 is slidingly received in first end 38 of central aperture 16. Seal 44 may be formed of any flexible material, such as urethane, that will provide a resilient seal between pin 42 and housing 14. A biasing member such as spring 46 is positioned between pin 42 and a spring stop 48, which has an aperture 50 extending therethrough and is secured to central aperture 16. In a preferred embodiment, external threads 52 on spring stop 48 engage internal threads 54 formed on central aperture 16. In a preferred embodiment, spring stop 48 may be a nut having external threads.

A shoulder 56 formed at first end 38 of central aperture 16 engages seal 44 of pin 42 to retain pin 42 within central aperture 16 and seal central aperture 16. Spring 46 acts to bias pin 42 and seal 44 outwardly into engagement with shoulder 56, providing a seal for valve 10. To open valve 10, pin 42 is pressed inwardly into central aperture 16 against the pressure of spring 46, providing a path between the interior of canister 12 and the environment or another device to which valve 10 is attached, e.g., a paintball gun adapter or regulator. When canister 12 is pressurized and pin 42 is depressed, pressurized fluid flows out of valve 10 through central aperture 16. Pin 42 is typically depressed by an adapter (not shown) of a device to be operated, such as a paintball gun. Spring 46 may be a coil spring, as illustrated here, or any other suitable biasing member.

Housing 14 includes a radially extending threaded aperture 58 in fluid communication with an exterior of housing 14 and central aperture 16. A pressure relief valve 60 having external threads 62 is secured within threaded aperture 58. In the illustrated embodiment, pressure relief valve 60 is a rupture valve 60 having a rupture disk (not shown). Rupture valve 60 works in known fashion to relieve pressure from canister 12 in the event that the pressure within canister 12 exceeds a predetermined level.

When screwing valve 10 into canister 12, it is desirable to impart a sufficient amount of torque to ensure that valve 10 and canister 12 will not work free from one another inadvertently. One way to ensure that a sufficient amount of torque is imparted is to use a torque wrench to measure the amount of torque. However, in many instances a suitable torque wrench is not available, and individuals unfamiliar with the operation of a torque wrench may not adequately secure valve 10 to canister 12.

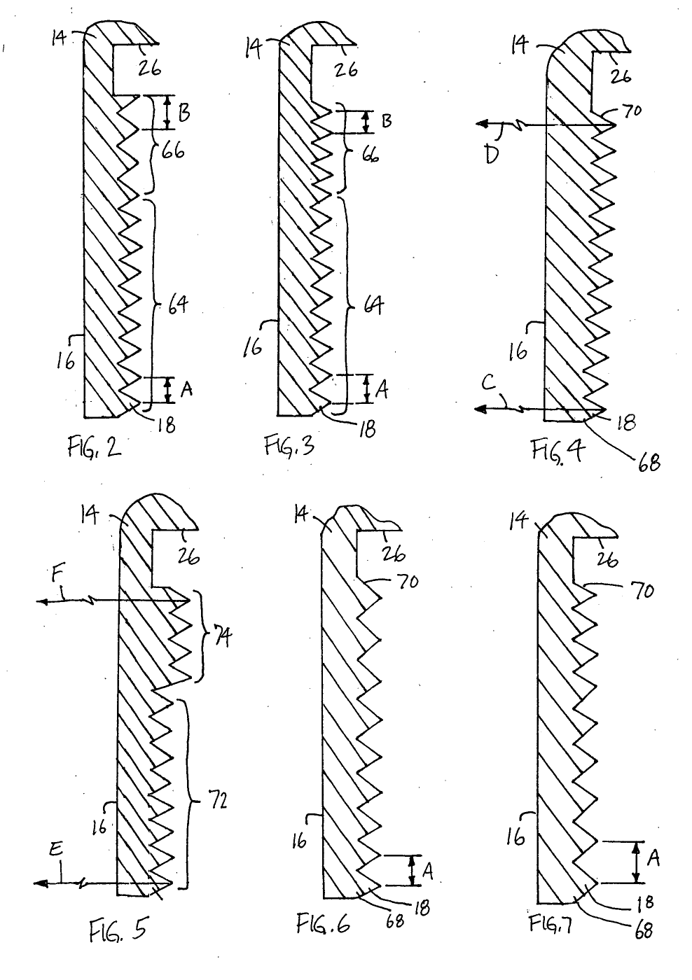

In certain preferred embodiments, thread 18 may have a characteristic with a value that is non-constant along its length, while the value of that same characteristic is uniform, or constant, along the length of thread 26 on canister 12. In accordance with a preferred embodiment, as illustrated in FIG. 2, thread 18 has a first portion 64 and a second portion 66. Second portion 66 is axially outward of first portion 64. In this embodiment, the characteristic that has a non-constant value along thread 18 is the pitch, or distance between adjacent crests or ridges of thread 18. As seen here, first portion 64 has a pitch A and second portion 66 has a pitch B, which is a value that is larger than pitch A. As valve 10 is threaded onto canister 12, an increased amount of torque is required as shoulder 26 approaches neck 20 of canister 12, since the pitch of thread 18 is larger in second portion 66 than it is in first portion 64 while the pitch of thread 26 of canister 12 is constant along its length and equal to the pitch of first portion 64. The difference in pitch between first portion 64 and second portion 66 can be adjusted such that at least a desired minimum of torque is applied to fully thread valve 10 onto canister 12 with shoulder 26 seated against neck 20. An alternate term to describe the pitch of thread 18 is threads per inch.

As illustrated here, thread 18 is split into two portions with different pitch values in a step-wise manner. It is to be appreciated that thread 18 may be divided into more than two portions, with the pitch of each successively outward portion of thread 18 being larger than the previous portion of thread 18.

Another embodiment is illustrated in FIG. 3, in which pitch B of second portion 66 is smaller than pitch A of first portion 64. In this embodiment as well, as valve 10 is threaded onto canister 12, an increased amount of torque is required as shoulder 26 approaches neck 20 of canister 12, since the pitch of thread 18 is greater in second portion 66 than it is in first portion 64 while the pitch of thread 26 of canister 12 is constant and equal to the pitch of first portion 64. The difference in pitch between first portion 64 and second portion 66 can be adjusted such that at least a desired minimum of torque is applied to fully thread valve 10 onto canister 12 with shoulder 26 seated against neck 20. This embodiment would require an increased torque as shoulder 26 approaches neck 20 due to the different pitch in second portion 66. It is to be appreciated that in such an embodiment, thread 18 can be divided into more than two portions, as described above with respect to FIG. 2.

Another embodiment is illustrated in FIG. 4, in which a thread characteristic value varies along the entire length of thread 18. As seen here, the major diameter of thread 18, that is, the diameter or housing 14 measured from crest to crest of thread 18, gradually increases from a first axially inner end 68 of thread 18 to a second axially outer end 70 of thread 18. Thus, as seen here, diameter C at first end 68 is smaller than diameter D at second end 70, with the diameter increasing along the length of thread 18. This embodiment would require a gradual increase in torque as valve 10 is threaded onto canister 12 due to the gradual increase in the diameter of thread 18.

The rate of increase in diameter along thread 18 can be varied, which will necessarily affect the required torque to thread valve 10 onto canister 12. As seen here, the diameter increases in linear fashion along thread 18. It is to be appreciated that the increase in diameter need not be linear, and any rate of increase is considered to be within the scope of the present invention.

Another embodiment is illustrated in FIG. 5, in which thread 18 is formed of a first portion 72 and a second portion 74. First portion 72 has a constant diameter E, matching the diameter of thread 24 of canister 12, and second portion 74 has a constant diameter F that is larger than diameter E. Thus, as valve 10 is threaded onto canister 12, an increased amount of torque is required as shoulder 26 approaches neck 20 of canister 12, since the pitch of thread 18 is different in second portion 74 than it is in first portion 72. The difference in pitch between first portion 72 and second portion 74 can be adjusted such that at least a desired minimum of torque is applied to fully thread valve 10 onto canister 12 with shoulder 26 seated against neck 20.

As illustrated here, thread 18 is split into two portions with different diameter values in a step-wise manner. It is to be appreciated that thread 18 may be divided into more than two portions, with the diameter of each successively outward portion of thread 18 being larger than the previous portion of thread 18.

Another embodiment is shown in FIG. 6, in which the pitch A of thread 18 varies along its length, increasing from a minimum amount at first end 68 to a maximum amount at second end 70. Consequently a gradual increase in torque would be required as valve 10 is threaded onto canister 12 due to the gradual increase in the pitch of thread 18.

The rate of increase in pitch along thread 18 can be varied, which will necessarily affect the required torque to thread valve 10 onto canister 12. As seen here, the pitch increases in linear fashion along thread 18. It is to be appreciated that the increase in pitch need not be linear, and any rate of increase is considered to be within the scope of the present invention.

Another embodiment is shown in FIG. 7, in which the pitch A of thread 18 varies along its length, decreasing from a maximum amount at first end 68 to a minimum amount at second end 70. This embodiment would also require a gradual increase in as valve 10 is threaded onto canister 12 due to the gradual decrease in the pitch of thread 18.

The rate of decrease in pitch along thread 18 can be varied, which will necessarily affect the required torque to thread valve 10 onto canister 12. As seen here, the pitch decreases in linear fashion along thread 18. It is to be appreciated that the decrease in pitch need not be linear, and any rate of decrease is considered to be within the scope of the present invention.

Consequently, it can be seen that many characteristics of thread 18 can be varied in order to ensure that a desired amount of torque is applied to secure valve 10 to canister 12. Other characteristics that can be varied along thread 18, either in step fashion or by a gradual change, will become readily apparent to those skilled in the art, given the benefit of this disclosure.

The components of valve 10 may be formed of any suitable materials including, for example, stainless steel or brass. Other suitable materials will become readily apparent to those skilled in the art, given the benefit of this disclosure.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

1. A valve for a pressurized canister comprising, in combination:
a housing having a central aperture extending therethrough, and a thread formed on an exterior surface thereof; and
a sealing member positioned in an axially outward end of the central aperture and axially moveable with respect to the housing to seal and unseal the central aperture;
wherein the thread has a constant diameter along its length, a first portion having a pitch with a first value, and a second portion having a pitch with a second value that is different than the first value.

2. (canceled)

3. The valve of claim 1, wherein a diameter of the thread increases along its length

4. The valve of claim 1, wherein the thread has a first portion having a diameter with a first value and a second portion having a diameter with a second value that is different than the first value.

5. The valve of claim 4, wherein the second value is greater than the first value.

6. The valve of claim 1, wherein the thread has a first end and a second end and a pitch of the thread increases from the first end to the second end.

7. The valve of claim 1, wherein the thread has a first end and a second end and a pitch of the thread decreases from the first end to the second end.

8. The valve of claim 1, further comprising a spring to bias the sealing member axially outwardly.

9. A valve for a pressurized canister comprising, in combination:
a housing having a central aperture extending therethrough, a first set of external threads, and a second set of external threads positioned radially inwardly of the first set of external threads;
a sealing member positioned in an axially outward end of the central aperture and axially moveable to seal and unseal the central aperture; and
a spring biasing the sealing member axially outwardly;
wherein the thread has a constant diameter along its length, a first portion having a pitch with a first value, and a second portion having a pitch with a second value that is different than the first value.

10. (canceled)

11. The valve of claim 9, wherein a diameter of the thread increases along its length

12. The valve of claim 9, wherein the thread has a first portion having a diameter with a first value and a second portion having a diameter with a second value that is different than the first value.

13. The valve of claim 12, wherein the second value is greater than the first value.

14. The valve of claim 9, wherein the thread has a first end and a second end and a pitch of the thread increases from the first end to the second end.

15. The valve of claim 9, wherein the thread has a first end and a second end and a pitch of the thread decreases from the first end to the second end.

16. The valve of claim 9, further comprising a second aperture in the housing in fluid communication with an exterior of the housing and the central aperture; and
a pressure relief valve positioned in the second aperture.

17. A pressurized canister valve assembly comprising, in combination:
a canister having a threaded opening;
a housing having a central aperture extending therethrough, a second aperture in fluid communication with an exterior of the housing and the central aperture, a first set of external threads, and a second set of external threads positioned radially inwardly of the first set of external threads, the second set of external threads engageable with the threaded opening of the canister;
a pressure relief valve positioned in the second aperture;
a sealing member positioned in an axially outward end of the central aperture and axially moveable to seal and unseal the central aperture; and
a spring biasing the sealing member axially outwardly;
wherein the second set of external threads has a thread pitch that has a non-constant value along its length and a constant diameter along its length, and the threaded opening of the canister has a thread pitch with a constant value along its length.

18. (canceled)

19. The pressurized canister valve assembly of claim 17, wherein the thread characteristic is a thread diameter.

20. The pressurized canister valve assembly of claim 17, wherein the pressure relief valve is a rupture valve.
